(19) United States
(12) Patent Application Publication
(10) Pub. No.: US 2016/0350245 A1
(43) Pub. Date: Dec. 1, 2016

(54) WORKLOAD BATCH SUBMISSION MECHANISM FOR GRAPHICS PROCESSING UNIT

(71) Applicants: Lei SHEN, Shanghai (CN); Yuting YANG, Sunnyvale, CA (US); Guei-Yuan LUEH, San Jose, CA (US); INTEL CORPORATION, Santa Clara, CA (US)

(72) Inventors: Lei SHEN, Shanghai (CN); Yuting YANG, Sunnyvale, CA (US); Guei-Yaun LUEH, San Jose, CA (US)

(21) Appl. No.: 15/112,871

(22) PCT Filed: Feb. 20, 2014
(86) PCT No.: PCT/CN2014/072310

§ 371 Date: Jul. 20, 2016

(51) Int. Cl. G06F 13/28; G06T 1/20; G06T 1/60

(52) U.S. Cl. CPC G06F 13/28; G06T 1/60; G06T 1/20; G06T 2200/28

(57) ABSTRACT

Technologies for submitting programmable workloads to a graphics processing unit include a computing device to prepare a batch submission of the programmable workloads to the graphics processing unit. The batch submission includes, in a single direct memory access packet, a separate dispatch command for each of the programmable workloads. The batch submission may include synchronization commands in between the dispatch commands.

### BACKGROUND

In computing devices, graphics processing units (GPUs) often supplement the central processing unit (CPU) by providing electronic circuitry that can perform mathematical operations rapidly. To do this, GPUs utilize extensive parallelism and many concurrent threads to overcome the latency of memory requests and computing. The capabilities of GPUs make them useful to accelerate high-performance graphics processing and parallel computing tasks. For instance, a GPU can accelerate the processing of two-dimensional (2D) or three-dimensional (3D) images in a surface for media or 3D applications.

Computer programs can be written specifically for the GPU. Examples of GPU applications include video encoding/decoding, three-dimensional games and other general purpose computing applications. The programming interfaces to GPUs are made up of two parts: one is a high-level programming language, which allows the developer to write programs to run on GPUs, and includes the corresponding compiler software, which compiles and generates the GPU-specific instructions (e.g., binary code) for the GPU programs. A set of GPU-specific instructions, which makes up a program that is executed by the GPU, may be referred to as a programmable workload or “kernel.” The other part of the host programming interface is the host runtime library, which runs on the CPU side and provides a set of APIs to allow the user to launch the GPU programs to GPU for execution. The two components work together as a GPU programming framework. Examples of such frameworks include, for example, the Open Computing Language (OpenCL), DirectX by Microsoft, and CUDA by NVIDIA. Depending on the application, multiple GPU workloads may be required to complete a single GPU task, such as image processing. The CPU runtime submits every workload to the GPU one by one by making up a GPU command buffer and passing it to GPU by a direct memory access (DMA) mechanism. The GPU command buffer may be referred to as a “DMA packet” or “DMA buffer.” Each time the GPU completes its processing of a DMA packet, the GPU issues an interrupt to the CPU. The CPU handles the interrupt by an interrupt service routine (ISR) and schedules a corresponding deferred procedure call (DPC). Existing runtimes, including OpenCL, submit each workload to the GPU as a separate DMA packet. Thus, with existing techniques, an ISR and a DPC are associated with every workload, at least.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device including a workload batch submission mechanism as disclosed herein;

FIG. 2 is a simplified block diagram of at least one embodiment of an environment of the computing device of FIG. 1;

FIG. 3 is a simplified flow diagram of at least one embodiment of a method for processing a batch submission with a GPU, which may be executed by the computing device of FIG. 1; and

FIG. 4 is a simplified flow diagram of at least one embodiment of a method for creating a batch submission of multiple workloads, which may be executed by the computing device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

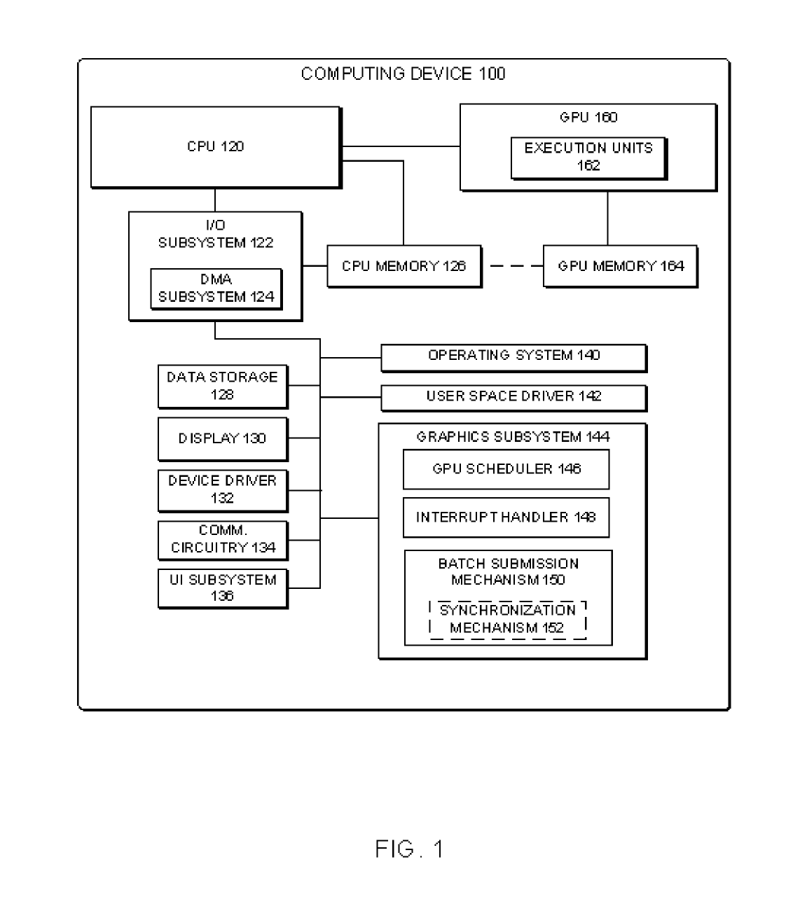

Referring now to FIG. 1, in one embodiment, a computing device 100 includes a central processing unit (CPU) 120 and a graphics processing unit 160. The CPU 120 is capable of submitting multiple workloads to the GPU 160 using a batch submission mechanism 150. In some embodiments, the batch submission mechanism 150 includes a synchronization mechanism 152. In operation, as described below, the computing device 100 combines multiple GPU workloads into a single DMA packet without merging (e.g., manually combining, by an application developer) the workloads into a single workload. In other words, with the batch submission mechanism 150, the computing device 100 can create a single DMA packet that contains multiple, separate GPU workloads. Among other things, the disclosed technologies can reduce the amount of GPU processing time, the amount of CPU utilization, and/or the number of graphics interrupts during, for example, video frame processing. As a result, the overall time required by the computing device 100 to complete a GPU task can be reduced. The disclosed technologies can improve the frame processing time and reduce power consumption in perceptual computing applications, among others. Perceptual computing applications involve the recognition of hand and finger gestures, speech recognition, face recognition and tracking, augmented reality, and/or other human gestural interactions by tablet computers, smart phones, and/or other computing devices.

The computing device 100 may be embodied as any type of device for performing the functions described herein. For example, the computing device 100 may be embodied as, without limitation, a smart phone, a tablet computer, a wearable computing device, a laptop computer, a notebook computer, a mobile computing device, a cellular telephone, a handset, a messaging device, a vehicle telematics device, a server computer, a workstation, a distributed computing system, a multiprocessor system, a consumer electronic device, and/or any other computing device configured to perform the functions described herein. As shown in FIG. 1, the illustrative computing device 100 includes the CPU 120, an input/output subsystem 122, a direct memory access (DMA) subsystem 124, a CPU memory 126, a data storage device 128, a display 130, communication circuitry 134, and a user interface subsystem 136. The computing device 100 further includes the GPU 160 and a GPU memory 164. Of course, the computing device 100 may include other or additional components, such as those commonly found in a mobile and/or stationary computers (e.g., various sensors and input/output devices), in other embodiments. Additionally, in some embodiments, one or more of the illustrative components may be incorporated in, or otherwise form a portion of, another component. For example, the CPU memory 126, or portions thereof, may be incorporated in the CPU 120 and/or the GPU memory 164 may be incorporated in the GPU 160, in some embodiments.

The CPU 120 may be embodied as any type of processor capable of performing the functions described herein. For example, the CPU 120 may be embodied as a single or multi-core processor(s), digital signal processor, microcontroller, or other processor or processing/controlling circuit. The GPU 160 is embodied as any type of graphics processing unit capable of performing the functions described herein. For example, the GPU 160 may be embodied as a single or multi-core processor(s), digital signal processor, microcontroller, floating-point accelerator, co-processor, or other processor or processing/controlling circuit designed to rapidly manipulate and alter data in memory. The GPU 160 includes a number of execution units 162. The execution units 162 may be embodied as an array of processor cores or parallel processors, which can execute a number of parallel threads. In various embodiments of the computing device 100, the GPU 160 may be embodied as a peripheral device (e.g., on a discrete graphics card), or may be located on the CPU motherboard or on the CPU die.

The CPU memory 126 and the GPU memory 164 may each be embodied as any type of volatile or non-volatile memory or data storage capable of performing the functions described herein. In operation, the memory 126, 164 may store various data and software used during operation of the computing device 100 such as operating systems, applications, programs, libraries, and drivers. For example, portions of the CPU memory 126 at least temporarily store command buffers and DMA packets that are created by the CPU 120 as disclosed herein, and portions of the GPU memory 164 at least temporarily store the DMA packets, which are transferred by the CPU 120 to the GPU memory 164 by the direct memory access subsystem 124.

The CPU memory 126 is communicatively coupled to the CPU 120, e.g., via the I/O subsystem 122, and the GPU memory 164 is similarly communicatively coupled to the GPU 160. The I/O subsystem 122 may be embodied as circuitry and/or components to facilitate input/output operations with the CPU 120, the CPU memory 126, the GPU 160 (and/or the execution units 162), the GPU memory 164, and other components of the computing device 100. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the CPU 120, the CPU memory 126, the GPU 160, the GPU memory 164, and/or other components of the computing device 100, on a single integrated circuit chip.

The illustrative I/O subsystem 122 includes a direct memory access (DMA) subsystem 124, which facilitates data transfer between the CPU memory 126 and the GPU memory 164. In some embodiments, the I/O subsystem 122 (e.g., the DMA subsystem 124) allows the GPU 160 to directly access the CPU memory 126 and allows the CPU 120 to directly access the GPU memory 164. The DMA subsystem 124 may be embodied as a DMA controller or DMA “engine,” such as a Peripheral Component Interconnect (PCI) device, a Peripheral Component Interconnect-Express (PCI-Express) device, an I/O Acceleration Technology (I/OAT) device, and/or others.

The data storage device 128 may be embodied as any type of device or devices configured for short-term or long-term storage of data such as, for example, memory devices and circuits, memory cards, hard disk drives, solid-state drives, or other data storage devices. The data storage device 128 may include a system partition that stores data and firmware code for the computing device 100. The data storage device 128 may also include an operating system partition that stores data files and executables for an operating system 140 of the computing device 100.

The display 130 may be embodied as any type of display capable of displaying digital information such as a liquid crystal display (LCD), a light emitting diode (LED), a plasma display, a cathode ray tube (CRT), or other type of display device. In some embodiments, the display 130 may be coupled to a touch screen or other user input device to allow user interaction with the computing device 100. The display 130 may be part of a user interface subsystem 136. The user interface subsystem 136 may include a number of additional devices to facilitate user interaction with the computing device 100, including physical or virtual control buttons or keys, a microphone, a speaker, a unidirectional or bidirectional still and/or video camera, and/or others. The user interface subsystem 136 may also include devices, such as motion sensors, proximity sensors, and eye tracking devices, which may be configured to detect, capture, and process various other forms of human interactions involving the computing device 100.

The computing device 100 further includes communication circuitry 134, which may be embodied as any communication circuit, device, or collection thereof, capable of enabling communications between the computing device 100 and other electronic devices. The communication circuitry 134 may be configured to use any one or more communication technology (e.g., wireless or wired communications) and associated protocols (e.g., Ethernet, Bluetooth®, Wi-Fi®, WiMAX, 3G/LTE, etc.) to effect such communication. The communication circuitry 134 may be embodied as a network adapter, including a wireless network adapter.

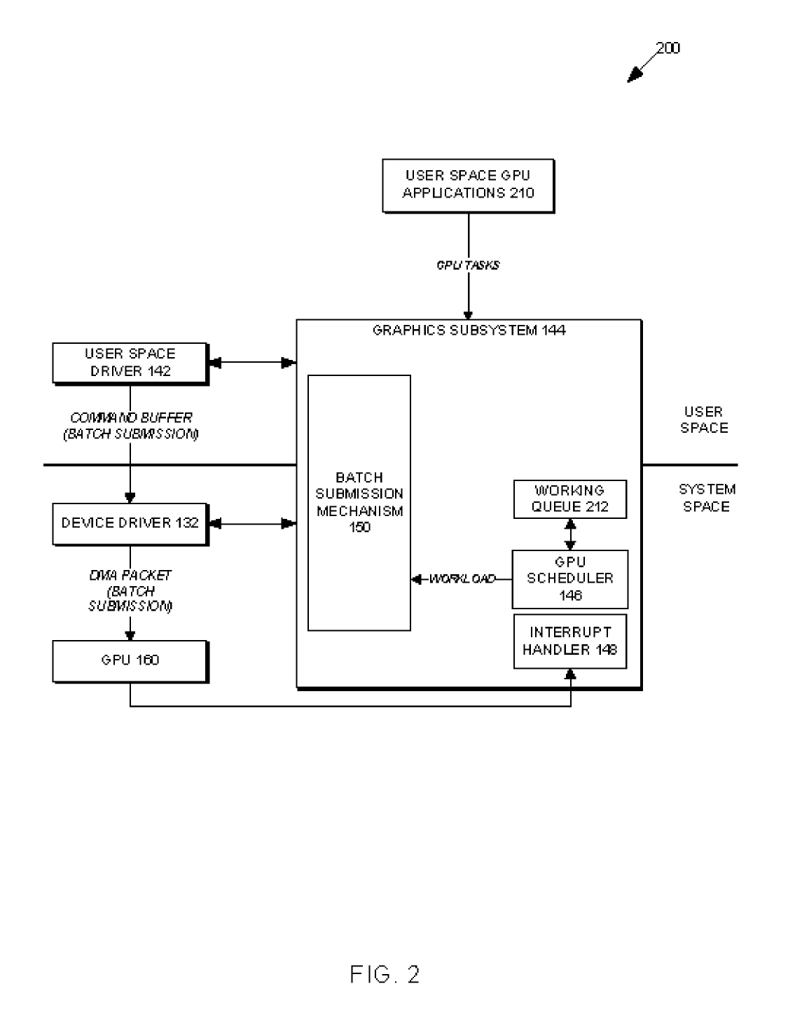

The illustrative computing device 100 also includes a number of computer program components, such as a device driver 132, an operating system 140, a user space driver 142, and a graphics subsystem 144. Among other things, the operating system 140 facilitates the communication between user space applications, such as GPU applications 210 (FIG. 2), and the hardware components of the computing device 100. The operating system 140 may be embodied as any operating system capable of performing the functions described herein, such as a version of WINDOWS by Microsoft Corporation, ANDROID by Google, Inc., and/or others. As used herein, “user space” may refer to, among other things, an operating environment of the computing device 100 in which end users may interact with the computing device 100, while “system space” may refer to, among other things, an operating environment of the computing device 100 in which programming code can interact directly with hardware components of the computing device 100. For example, user space applications may interact directly with end users and with their own allocated memory, but not interact directly with hardware components or memory not allocated to the user space application. On the other hand, system space applications may interact directly with hardware components, their own allocated memory, and memory allocated to a currently running user space application, but may not interact directly with end users. Thus, system space components of the computing device 100 may have greater privileges than user space components of the computing device 100.

In the illustrative embodiment, the user space driver 142 and the device driver 132 cooperate as a “driver pair,” and handle communications between user space applications, such as GPU applications 210 (FIG. 2), and hardware components, such as the display 130. In some embodiments, the user space driver 142 may be a “general-purpose” driver that can, for example, communicate device-independent graphics rendering tasks to a variety of different hardware components (e.g., different types of displays), while the device driver 132 translates the device-independent tasks into commands that a specific hardware component can execute to accomplish the requested task. In other embodiments, portions of the user space driver 142 and the device driver 132 may be combined into a single driver component. Portions of the user space driver 142 and/or the device driver 132 may be included in the operating system 140, in some embodiments. The drivers 132, 142 are, illustratively, display drivers; however, aspects of the disclosed batch submission mechanism 150 are applicable to other applications, e.g., any kind of task that may be offloaded to the GPU 160 (e.g., where the GPU 160 is configured as a general purpose GPU or GPGPU).

The graphics subsystem 144 facilitates communications between the user space driver 142, the device driver 132, and one or more user space applications, such as the GPU applications 210. The graphic subsystem 144 may be embodied as any type of computer program subsystem capable of performing the functions described herein, such as an application programming interface (API) or suite of APIs, a combination of APIs and runtime libraries, and/or other computer program components. Examples of graphics subsystems include the Media Development Framework (MDF) runtime library by Intel Corporation, OpenCL runtime library, and the DirectX Graphics Kernel Subsystem and Windows Display Driver Model by Microsoft Corporation.

The illustrative graphics subsystem 144 includes a number of computer program components, such as a GPU scheduler 146, an interrupt handler 148, and the batch submission subsystem 150. The GPU scheduler 146 communicates with the device driver 132 to control the submission of DMA packets in a working queue 212 (FIG. 2) to the GPU 160. The working queue 212 may be embodied as, for example, any type of first in, first out data structure, or other type of data structure that is capable of at least temporarily storing data relating to GPU tasks. In the illustrative embodiments, the GPU 160 generates an interrupt each time the GPU 160 finishes processing a DMA packet, and such interrupts are received by the interrupt handler 148. Since interrupts can be issued by the GPU 160 for other reasons (like errors and exceptions), in some embodiments, the GPU scheduler 146 waits until the graphics subsystem 144 has received confirmation from the device driver 132 that a task is complete before scheduling the next task in the working queue 212. The batch submission mechanism 150 and the optional synchronization mechanism 152 are described in more detail below.

Referring now to FIG. 2, in some embodiments, the computing device 100 establishes an environment 200 during operation. The illustrative environment 200 includes a user space and a system space as described above. The various modules of the environment 200 may be embodied as hardware, firmware, software, or a combination thereof. Additionally, in some embodiments, some or all of the modules of the environment 200 may be integrated with, or form part of, other modules or software/firmware structures. In the user space, the graphics subsystem 144 receives GPU tasks from one or more user space GPU applications 210. The GPU applications 210 may include, for example, video players, games, messaging applications, web browsers, and social media applications. The GPU tasks may include frame processing, wherein, for example, individual frames of a video image, stored in a frame buffer of the computing device 100, are processed by the GPU 160 for display by the computing device 100 (e.g., by the display 130). As used herein, the term “frame” may refer to, among other things, a single, still, two-dimensional or three-dimensional digital image, and may be one frame of a digital video (which includes multiple frames). For each GPU task, the graphics subsystem 144 creates one or more workloads to be executed by the GPU 160. To submit the workloads to the GPU 160, the user space driver 142 creates a command buffer using the batch submission mechanism 150. The command buffer created by the user space driver 142 with the batch submission mechanism 150 contains high-level program code representing the GPU commands needed to establish a working mode in which multiple individual workloads are dispatched for processing by the GPU 160 within a single DMA packet. In the system space, the device driver 132, in communication with the graphics subsystem 144, converts the command buffer into the DMA packet, which contains the GPU-specific commands that can be executed by the GPU 160 to perform the batch submission.

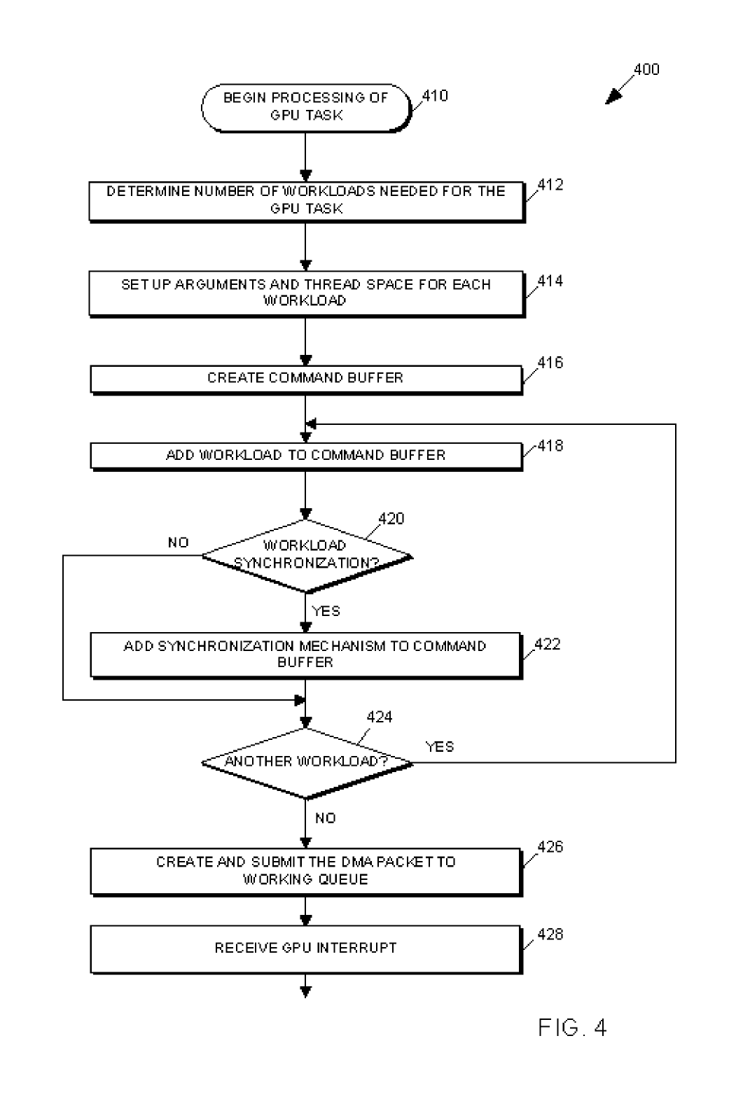

The batch submission mechanism 150 includes program code that enables the creation of the command buffer as disclosed herein. An example of a method 400 that may be implemented by the program code of the batch submission mechanism 150 to create the command buffer is shown in FIG. 4, described below. The synchronization mechanism 152 enables the working mode established by the batch submission mechanism 150 to include synchronization. That is, with the synchronization mechanism 152, the batch submission mechanism 150 allows a working mode to be selected from a number of optional working modes (e.g., with or without synchronization). The illustrative batch submission mechanism 150 enables two working mode options: one with synchronization and one without synchronization. Synchronization may be needed in situations where one workload produces output that is consumed by another workload. Where there are no dependencies between workloads, a working mode without synchronization may be used. In the no-synchronization working mode, the batch submission mechanism 150 creates the command buffer to separately dispatch each of the workloads to the GPU in parallel (in the same command buffer), such that all of the workloads may be executed on the execution units 162 simultaneously. To do this, the batch submission mechanism 150 inserts one dispatch command into the command buffer for each workload. An example of pseudo code for a command buffer that may be created by the batch submission mechanism 150 for multiple workloads, without synchronization, is shown in Code Example 1 below.

Code Example 1. Command buffer for multiple workloads,
without synchronization.
Setup commands

MEDIA_OBJECT_WALKER(Workload 1)
MEDIA_OBJECT_WALKER(Workload 2)
. . .
MEDIA_OBJECT_WALKER(Workload n)
PIPE_CONTROL

In Code Example 1, the setup command may include GPU commands to prepare the information that the GPU 160 needs to execute the workloads on the execution units 162. Such commands may include, for example, cache configuration commands, surface state setup commands, media state setup commands, pipe control commands, and/or others. The media object walker command causes the GPU 160 to dispatch multiple threads running on the execution units 162, for the workload identified as a parameter in the command. The pipe control command ensures that all of the preceding commands finish executing before the GPU finishes execution of the command buffer. Thus, the GPU 160 only generates one interrupt (ISR), at the completion of the processing of all of the individually-dispatched workloads contained in the command buffer. In return, the CPU 120 only generates one deferred procedure call (DPC). In this way, multiple workloads contained in one command buffer only generate one ISR and one DPC.

For comparison purposes, an example of pseudo code for a command buffer that may be created by existing techniques (such as current versions of OpenCL) for multiple workloads, without synchronization, is shown in Code Example 2 below.

Code Example 2. Command buffer for multiple workloads,
manual merging technique.
(PRIOR ART)
Setup commands

MEDIA_OBJECT_WALKER(Merged_Workload 1)
PIPE_CONTROL

In Code Example 2, the setup commands may be similar to those described above. However and multiple workloads are combined manually by a developer (e.g., a GPU programmer) into a single workload, which is then dispatched to the GPU 160 by a single media object walker command. Although a single DMA packet is created from the Code Example 2, resulting in one IPC and DPC, the merged workload is much larger than the separate workloads taken individually. Such a large workload can strain the hardware resources of the GPU 160 (e.g., the GPU instruction cache and/or registers). As noted above, a known alternative to the manual merging of workloads is to create separate DMA packets for each workload; however, separate DMA packets result in many more IPCs and DPCs than a single DMA packet containing multiple workloads as disclosed herein.

In the workload synchronization working mode, the batch submission mechanism 150 creates the command buffer to separately dispatch each of the workloads to the GPU 160 in the same command buffer, and the synchronization mechanism 152 inserts a synchronization command between the workload dispatch commands to ensure that the workload dependency conditions are met. To do this, the batch submission mechanism 150 inserts one dispatch command into the command buffer for each workload and the synchronization mechanism 152 inserts the appropriate pipe control command after each dispatch command, as needed. An example of pseudo code for a command buffer that may be created by the batch submission mechanism 150 (including the synchronization mechanism 152) for multiple workloads, with synchronization, is shown in Code Example 3 below.

Code Example 3. Command buffer for multiple workloads,
with synchronization.
Setup commands

MEDIA_OBJECT_WALKER(Workload 1)
PIPE_CONTROL(sync 2,1)
MEDIA_OBJECT_WALKER(Workload 2)
PIPE_CONTROL(sync 3,2)
MEDIA_OBJECT_WALKER(Workload 3)
. . .
MEDIA_OBJECT_WALKER(Workload n)
PIPE_CONTROL

In Code Example 3, the setup commands and media object walker commands are similar to those described above with reference to Code Example 1. The pipe control (sync) command includes parameters that identify to the pipe control command the workloads that have a dependency condition. For example, the pipe control (sync 2,1) command ensures that the media object walker (Workload 1) command finishes executing before the GPU 160 begins execution of the media object walker (Workload 2) command. Similarly, the pipe control (sync 3,2) command ensures that the media object walker (Workload 2) command finishes executing before the GPU 160 begins execution of the media object walker (Workload 3) command.

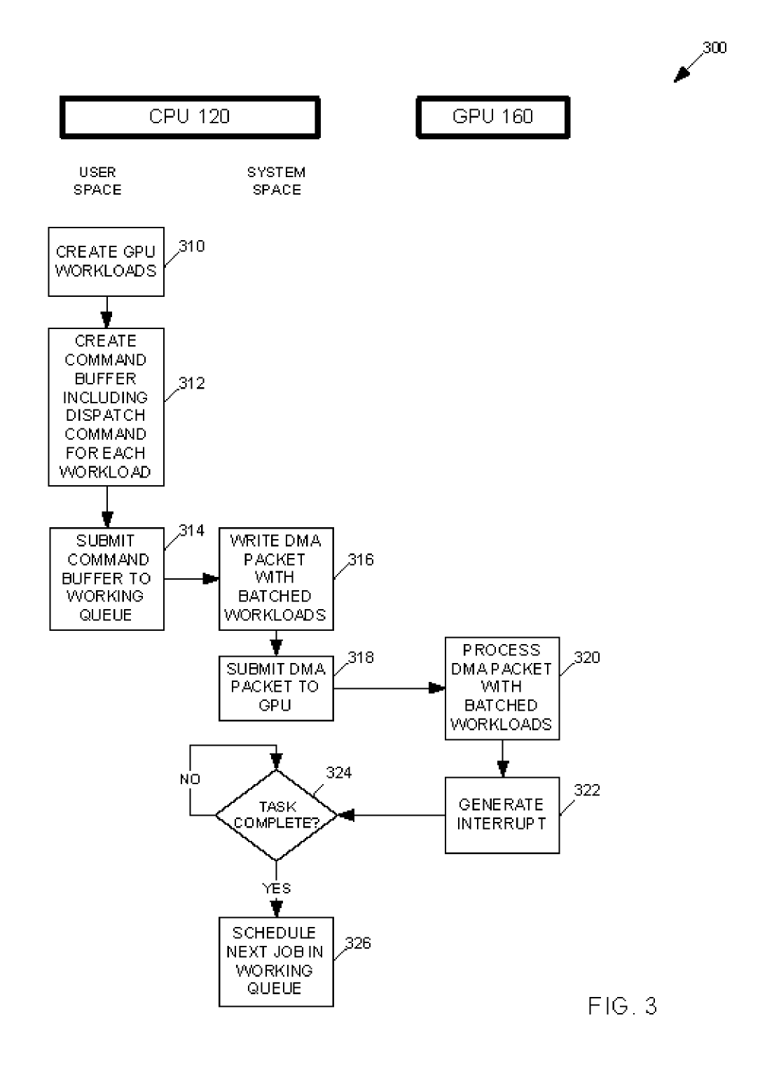

Referring now to FIG. 3, an example of a method 300 for processing a GPU task, is shown. Portions of the method 300 may be executed by the computing device 100; for example, by the CPU 120 and the GPU 160. Illustratively, blocks 310, 312, 314 are executed in user space (e.g., by the batch submission mechanism 150 and/or the user space driver 142); blocks 316, 318, 324, 326 are executed in system space (e.g., by the graphics scheduler 146, interrupt handler 148, and/or the device driver 132); and blocks 320, 322 are executed by the GPU 160 (e.g., by the execution units 162). At block 310, the computing device 100 (e.g., the CPU 120) creates a number of GPU workloads. Workloads may be created by, for example, the graphics subsystem 144, in response to a GPU task requested by a user space GPU application 210. As noted above, a single GPU task (such as frame processing) may require multiple workloads. At block 312, the computing device 100 (e.g., the CPU 120) creates the command buffer for the GPU task by, for example, the batch submission mechanism 150 described above. To do this, the computing device 100 creates a separate dispatch command for each workload to be included in the command buffer. The dispatch commands and other commands in the command buffer are embodied as human-readable program code, in some embodiments. At block 314, the computing device 100 (e.g., the CPU 120, by the user space driver 142) submits the command buffer to the graphics subsystem 144 for execution by the GPU 160.

At block 316, the computing device 100 (e.g., the CPU 120) prepares the DMA packet from the command buffer, including the batched workloads. To do this, the illustrative device driver 132 validates the command buffer and writes the DMA packet in the device-specific format. In embodiments in which the command buffer is embodied as human-readable program code, the computing device 100 converts the human-readable commands in the command buffer to machine-readable instructions that can be executed by the GPU 160. Thus, the DMA packet contains machine-readable instructions, which may correspond to human-readable commands contained in the command buffer. At block 318, the computing device 100 (e.g., the CPU 120) submits the DMA packet to the GPU 160 for execution. To do this, the computing device (e.g., the CPU 120, by the GPU scheduler 146 in coordination with the device driver 132) assigns memory addresses to the resources in the DMA packet, assigns a unique identifier to the DMA packet (e.g., a buffer fence ID), and queues the DMA packet to the GPU 160 (e.g., to an execution unit 162).

At block 320, the computing device 100 (e.g., the GPU 160) processes the DMA packet with the batched workloads. For example, the GPU 160 may process each workload on a different execution unit 162 using multiple threads. When the GPU 160 finishes processing the DMA packet (subject to any synchronization commands that may be included in the DMA packet), the GPU 160 generates an interrupt, at block 322. The interrupt is received by the CPU 120 (by, e.g., the interrupt handler 148). At block 324, the computing device 100 (e.g., the CPU 120) determines whether the processing of the DMA packet by the GPU 160 is complete. To do this, the device driver 132 evaluates the interrupt information, including the identifier (e.g., buffer fence ID) of the DMA packet just completed. If the device driver 132 concludes that the processing of the DMA packet by the GPU 160 has finished, the device driver 132 notifies the graphics subsystem 144 (e.g., the GPU scheduler 146) that the DMA packet processing is complete, and queues a deferred procedure call (DPC). At block 326, the computing device 100 (e.g., the CPU 120) notifies the GPU scheduler 146 that the DPC has completed. To do this, the DPC may call a callback function provided by the GPU scheduler 146. In response to the notification that the DPC is complete, the computing device (e.g., the CPU 120, by the GPU scheduler 146) schedules the next GPU task in the working queue 212 for processing by the GPU 160.

Referring now to FIG. 4, an example of a method 400 for creating a command buffer with batched workloads is shown. Portions of the method 400 may be executed by the computing device 100; for example, by the CPU 120. At block 410, the computing device 100 begins the processing of a GPU task (e.g., in response to a request from a user space software application), by creating the command buffer. Aspects of the disclosed methods and devices may be implemented using, for instance, the LoadProgram, CreateKernel, CreateTask, AddKernel, and AddSync Media Development Framework (MDF) runtime APIs and/or others. For example, with the Media Development Framework (MDF) runtime APIs, a pCmDev->LoadProgram(pCISA,uCISASize,pCmProgram) command may be used to load the program from a persistently stored file to memory, and an enqueue( ) API may be used to create the command buffer and submit the command buffer to the working queue 212. At block 312, the computing device 100 determines the number of workloads that are needed to perform the requested GPU task. To do this, the computing device 100 may define (e.g., via programming code) a maximum number of workloads for a given task. The maximum number of workloads can be determined, for example, based on the allocated resources in the CPU 120 and/or the GPU 160 (such as the command buffer size, or the global state heap allocated in graphic memory). The number of workloads needed may vary depending on, for example, the nature of the requested GPU task and/or the type of issuing application. For example, in perceptual computing applications, individual frames may require a number of workloads (e.g., 33 workloads, in some cases) to process the frame. At block 414, the computing device 100 sets up the arguments and thread space for each workload. To do this, the computing device 100 executes a “create workload” command for each workload. For example, with the Media Development Framework runtime APIs, a pCmDev->CreateKernel(pCmProgram, pCmKernelN) may be used. At block 416, the computing device 100 creates the command buffer and adds the first workload to the command buffer. For example, with the Media Development Framework runtime APIs, a CreateTask(pCmTask) command may be used to create the command buffer, and an AddKernel(KernelN) command may be used to add the workload to the command buffer.

At block 420, the computing device 100 determines whether workload synchronization is required. To do this, the computing device 100 determines whether the output of the first workload is used as input to any other workloads (e.g., by examining parameters or arguments of the create workload commands). If synchronization is needed, the computing device inserts the synchronization command in the command buffer after the create workload command. For example, with the Media Development Framework runtime APIs, a pCmTask->AddSync( ) API may be used. At block 424, the computing device 100 determines whether there is another workload to be added to the command buffer. If there is another workload to be added to the command buffer, the computing device 100 returns to block 418 and adds the workload to the command buffer. If there are no more workloads to be added to the command buffer, the computing device 100 creates the DMA packet and submits the DMA packet to the working queue 212. The GPU scheduler 146 will submit the DMA packet to the GPU 160 if the GPU 160 is currently available to process the DMA packet, at block 426. At block 428, the computing device 100 (e.g., the CPU 120) waits for a notification from the GPU 160 that the GPU 160 has completed executing the DMA packet, and the method 400 ends. Following block 428, the computing device 100 may initiate the creation of another command buffer as described above.

Table 1 below illustrates experimental results that were obtained after applying the disclosed batch submission mechanism to a perceptual computing application with synchronization.

TABLE 1
Experimental results.

| | | | | | | System | | | Estimated |
|---|---|---|---|---|---|---|---|---|---|
| | Number | Overall | GPU | | CPU | CPU | | Number | Total |
| | of Tasks | Frame | Frame | GPU | Frame | Frame | CPU | of | Time Per |
| | per | Time | Processing | Utilization | Processing | Processing | Utilization | Graphics | Frame |
| | Frame | (ms) | Time (ms) | (%) | Time (ms) | Time (ms) | (% 1 Core) | ISR/DPC | (μs) |
| With Batch | 3 | 1.51 | 1.31 | 94.15 | 0.50 | 0.08 | 38.20 | 6 | 60 |
| Submission | | | | | | | | | |
| Mechanism | | | | | | | | | |
| Without | 33 | 2.05 | 1.93 | 86.75 | 1.53 | 0.30 | 89.10 | 66 | 188 |
| Batch | | | | | | | | | |
| Submission | | | | | | | | | |
| Mechanism | | | | | | | | | |
| % | 90.91 | 26.34 | 32.12 | 7.85 | 67.22 | 74.60 | 57.13 | 90.91 | 68.08 |
| Improvement | | | | | | | | | |

As shown in Table 1, performance gains have been realized after applying the batch submission mechanism disclosed herein to process multiple synchronized GPU workloads in one DMA packet, in a perceptual computing application. These results suggests that the GPU 160 is better utilized by the CPU 120 when the disclosed batch submission mechanism is used, which should lead to reductions in system power consumption. These results may be attributed to, among other things, the reduced number of IPCs and DPC calls, as well as the smaller number of DMA packets needing to be scheduled.

### EXAMPLES

Illustrative examples of the technologies disclosed herein are provided below. An embodiment of the technologies may include any one or more, and any combination of, the examples described below.

Example 1 includes a computing device for executing programmable workloads, the computing device comprising a central processing unit to create a direct memory access packet, the direct memory access packet comprising a separate dispatch instruction for each of the programmable workloads; a graphics processing unit to execute the programmable workloads, each of the programmable workloads comprising a set of graphics processing unit instructions; wherein each of the separate dispatch instructions in the direct memory access packet is to initiate processing by the graphics processing unit of one of the programmable workloads; and a direct memory access subsystem to communicate the direct memory access packet from memory accessible by the central processing unit to memory accessible by the graphics processing unit.

Example 2 includes the subject matter of Example 1, wherein the central processing unit is to create a command buffer comprising dispatch commands embodied in human-readable computer code, and the dispatch instructions in the direct memory access packet correspond to the dispatch commands in the command buffer.

Example 3 includes the subject matter of Example 2, wherein the central processing unit executes a user space driver to create the command buffer and the central processing unit executes a device driver to create the direct memory access packet.

Example 4 includes the subject matter of any of Examples 1-3, wherein the central processing unit is to create a first type of direct memory access packet for programmable workloads that have a dependency relationship and a second type of direct memory access packet for programmable workloads that do not have a dependency relationship, wherein the first type of direct memory access packet is different than the second type of direct memory access packet.

Example 5 includes the subject matter of Example 4, wherein the first type of direct memory access packet comprises a synchronization instruction between two of the dispatch instructions, and the second type of direct memory access packet does not comprise any synchronization instructions between the dispatch instructions.

Example 6 includes the subject matter of any of Examples 1-3, wherein each of the dispatch instructions in the direct memory access packet is to initiate processing of one of the programmable workloads by an execution unit of the graphics processing unit.

Example 7 includes the subject matter of any of Examples 1-3, wherein the direct memory access packet comprises a synchronization instruction to ensure that execution of one of the programmable workloads by the graphics processing unit finishes before the graphics processing unit begins execution of another of the programmable workloads.

Example 8 includes the subject matter of any of Examples 1-3, wherein each of the programmable workloads comprises instructions to execute a graphics processing unit task requested by a user space application.

Example 9 includes the subject matter of Example 8, wherein the user space application comprises a perceptual computing application.

Example 10 includes the subject matter of Example 8, wherein the graphics processing unit task comprises processing of a frame of a digital video.

Example 11 includes a computing device for submitting programmable workloads to a graphics processing unit, each of the programmable workloads comprising a set of graphics processing unit instructions, the computing device comprising: a graphics subsystem to facilitate communication between a user space application and the graphics processing unit; and a batch submission mechanism to create a single command buffer comprising separate dispatch commands for each of the programmable workloads, wherein each of the separate commands in the direct memory access packet is to separately initiate processing by the graphics processing unit of one of the programmable workloads.

Example 12 includes the subject matter of Example 11, and comprises a device driver to create a direct memory access packet, the direct memory access packet comprising graphics processing unit instructions corresponding to the dispatch commands in the command buffer.

Example 13 includes the subject matter of Example 11 or Example 12, wherein the dispatch commands are to cause the graphics processing unit to execute all of the programmable workloads in parallel.

Example 14 includes the subject matter of Example 11 or Example 12, and comprises a synchronization mechanism to insert into the command buffer a synchronization command to cause the graphics processing unit to complete execution of a programmable workload before beginning the execution of another programmable workload.

Example 15 includes the subject matter of Example 14, wherein the synchronization mechanism is embodied as a component of the batch submission mechanism.

Example 16 includes the subject matter of any of Examples 11-13, wherein the batch submission mechanism is embodied as a component of the graphics subsystem.

Example 17 includes the subject matter of Example 16, wherein the graphics subsystem is embodied as one or more of: an application programming interface, a plurality of application programming interfaces, and a runtime library.

Example 18 includes a method for submitting programmable workloads to a graphics processing unit, the method comprising, with a computing device: creating a command buffer; adding a plurality of dispatch commands to the command buffer, each of the dispatch commands to initiate execution of one of the programmable workloads by a graphics processing unit of the computing device; and creating a direct memory access packet comprising graphics processing unit instructions corresponding to the dispatch commands in the command buffer.

Example 19 includes the subject matter of Example 18, and comprises communicating the direct memory access packet to memory accessible by the graphics processing unit.

Example 20 includes the subject matter of Example 18, and comprises inserting a synchronization command between two of the dispatch commands in the command buffer, wherein the synchronization command is to ensure that the graphics processing unit completes the processing of one of the programmable workloads before the graphics processing unit begins processing another of the programmable workloads.

Example 21 includes the subject matter of Example 18, and comprises formulating each of the dispatch commands to create a set of arguments for one of the programmable workloads.

Example 22 includes the subject matter of Example 18, and comprises formulating each of the dispatch commands to create a thread space for one of the programmable workloads.

Example 23 includes the subject matter of any of Examples 18-23, and comprises, by a direct memory access subsystem of the computing device, transferring the direct memory access packet from memory accessible by the central processing unit to memory accessible by the graphics processing unit.

Example 24 includes a computing device comprising the central processing unit, the graphics processing unit, and memory having stored therein a plurality of instructions that when executed by the central processing unit cause the computing device to perform the method of any of Examples 18-23.

Example 25 includes one or more machine readable storage media comprising a plurality of instructions stored thereon that in response to being executed result in a computing device performing the method of any of Examples 18-23.

Example 26 includes a computing device comprising means for performing the method of any of Examples 18-23.

Example 27 includes a method for executing programmable workloads, the method comprising, with a computing device: by a central processing unit of the computing device, creating a direct memory access packet, the direct memory access packet comprising a separate dispatch instruction for each of the programmable workloads; by a graphics processing unit of the computing device, executing the programmable workloads, each of the programmable workloads comprising a set of graphics processing unit instructions; wherein each of the separate dispatch instructions in the direct memory access packet is to initiate processing by the graphics processing unit of one of the programmable workloads; and by a direct memory access subsystem of the computing device, communicating the direct memory access packet from memory accessible by the central processing unit to memory accessible by the graphics processing unit.

Example 28 includes the subject matter of Example 27, and comprises, by the central processing unit, creating a command buffer comprising dispatch commands embodied in human-readable computer code, wherein the dispatch instructions in the direct memory access packet correspond to the dispatch commands in the command buffer.

Example 29 includes the subject matter of Example 28, and comprises, by the central processing unit, executing a user space driver to create the command buffer, wherein the central processing unit executes a device driver to create the direct memory access packet.

Example 30 includes the subject matter of any of Examples 27-29, and comprises, by the central processing unit, creating a first type of direct memory access packet for programmable workloads that have a dependency relationship and creating a second type of direct memory access packet for programmable workloads that do not have a dependency relationship, wherein the first type of direct memory access packet is different than the second type of direct memory access packet.

Example 31 includes the subject matter of Example 30, wherein the first type of direct memory access packet comprises a synchronization instruction between two of the dispatch instructions, and the second type of direct memory access packet does not comprise any synchronization instructions between the dispatch instructions.

Example 32 includes the subject matter of any of Examples 27-29, and comprises, by each of the dispatch instructions in the direct memory access packet, initiating processing of one of the programmable workloads by an execution unit of the graphics processing unit.

Example 33 includes the subject matter of any of Examples 27-29, and comprises, by a synchronization instruction in the direct memory access packet, ensuring that execution of one of the programmable workloads by the graphics processing unit finishes before the graphics processing unit begins execution of another of the programmable workloads.

Example 34 includes the subject matter of any of Examples 27-29, and comprises, by each of the programmable workloads, executing a graphics processing unit task requested by a user space application.

Example 35 includes the subject matter of Example 34, wherein the user space application comprises a perceptual computing application.

Example 36 includes the subject matter of Example 34, wherein the graphics processing unit task comprises processing of a frame of a digital video.

Example 37 includes a computing device comprising the central processing unit, the graphics processing unit, the direct memory access subsystem, and memory having stored therein a plurality of instructions that when executed by the central processing unit cause the computing device to perform the method of any of Examples 27-36.

Example 38 includes one or more machine readable storage media comprising a plurality of instructions stored thereon that in response to being executed result in a computing device performing the method of any of Examples 27-36.

Example 39 includes a computing device comprising means for performing the method of any of Examples 27-36.

Example 40 includes method for submitting programmable workloads to a graphics processing unit of a computing device, each of the programmable workloads comprising a set of graphics processing unit instructions, the method comprising: by a graphics subsystem of the computing device, facilitating communication between a user space application and the graphics processing unit; and by a batch submission mechanism of the computing device, creating a single command buffer comprising separate dispatch commands for each of the programmable workloads, wherein each of the separate commands in the direct memory access packet is to separately initiate processing by the graphics processing unit of one of the programmable workloads.

Example 41 includes the subject matter of Example 40, and comprises, by a device driver of the computing device, creating a direct memory access packet, wherein the direct memory access packet comprises graphics processing unit instructions corresponding to the dispatch commands in the command buffer.

Example 42 includes the subject matter of Example 40 or Example 41, and comprises, by the dispatch commands, causing the graphics processing unit to execute all of the programmable workloads in parallel.

Example 43 includes the subject matter of Example 40 or Example 41, and comprises, by a synchronization mechanism of the computing device, inserting into the command buffer a synchronization command to cause the graphics processing unit to complete execution of a programmable workload before the graphics processing unit begins the execution of another programmable workload.

Example 44 includes the subject matter of Example 43, wherein the synchronization mechanism is embodied as a component of the batch submission mechanism.

Example 45 includes the subject matter of any of Examples 40-44, wherein the batch submission mechanism is embodied as a component of the graphics subsystem.

Example 46 includes the subject matter of any of Examples 40-44, wherein the graphics subsystem is embodied as one or more of: an application programming interface, a plurality of application programming interfaces, and a runtime library.

Example 47 includes a computing device comprising the central processing unit, the graphics processing unit, the direct memory access subsystem, and memory having stored therein a plurality of instructions that when executed by the central processing unit cause the computing device to perform the method of any of Examples 40-46.

Example 48 includes one or more machine readable storage media comprising a plurality of instructions stored thereon that in response to being executed result in a computing device performing the method of any of Examples 40-46.

Example 49 includes a computing device comprising means for performing the method of any of Examples 40-46.

1-25. (canceled)

26. A computing device for executing programmable workloads, the computing device comprising:
a central processing unit to create a direct memory access packet, the direct memory access packet comprising a separate dispatch instruction for each of the programmable workloads;
a graphics processing unit to execute the programmable workloads, each of the programmable workloads comprising a set of graphics processing unit instructions; wherein each of the separate dispatch instructions in the direct memory access packet is to initiate processing by the graphics processing unit of one of the programmable workloads; and
a direct memory access subsystem to communicate the direct memory access packet from memory accessible by the central processing unit to memory accessible by the graphics processing unit.

27. The computing device of claim 26, wherein the central processing unit is to create a command buffer comprising dispatch commands embodied in human-readable computer code, and the dispatch instructions in the direct memory access packet correspond to the dispatch commands in the command buffer.

28. The computing device of claim 27, wherein the central processing unit executes a user space driver to create the command buffer and the central processing unit executes a device driver to create the direct memory access packet.

29. The computing device of claim 26, wherein the central processing unit is to create a first type of direct memory access packet for programmable workloads that have a dependency relationship and a second type of direct memory access packet for programmable workloads that do not have a dependency relationship, wherein the first type of direct memory access packet is different than the second type of direct memory access packet.

30. The computing device of claim 29, wherein the first type of direct memory access packet comprises a synchronization instruction between two of the dispatch instructions, and the second type of direct memory access packet does not comprise any synchronization instructions between the dispatch instructions.

31. The computing device of claim 26, wherein each of the dispatch instructions in the direct memory access packet is to initiate processing of one of the programmable workloads by an execution unit of the graphics processing unit.

32. The computing device of claim 26, wherein the direct memory access packet comprises a synchronization instruction to ensure that execution of one of the programmable workloads by the graphics processing unit finishes before the graphics processing unit begins execution of another of the programmable workloads.

33. The computing device of claim 26, wherein each of the programmable workloads comprises instructions to execute a graphics processing unit task requested by a user space application.

34. The computing device of claim 33, wherein the user space application comprises a perceptual computing application.

35. The computing device of claim 33, wherein the graphics processing unit task comprises processing of a frame of a digital video.

36. A method for executing programmable workloads, the method comprising, with a computing device:
by a central processing unit of the computing device, creating a direct memory access packet, the direct memory access packet comprising a separate dispatch instruction for each of the programmable workloads;
by a graphics processing unit of the computing device, executing the programmable workloads, each of the programmable workloads comprising a set of graphics processing unit instructions; wherein each of the separate dispatch instructions in the direct memory access packet is to initiate processing by the graphics processing unit of one of the programmable workloads; and
by a direct memory access subsystem of the computing device, communicating the direct memory access packet from memory accessible by the central processing unit to memory accessible by the graphics processing unit.

37. The method of claim 36, comprising, by the central processing unit, creating a command buffer comprising dispatch commands embodied in human-readable computer code, wherein the dispatch instructions in the direct memory access packet correspond to the dispatch commands in the command buffer.

38. The method of claim 37, comprising, by the central processing unit, executing a user space driver to create the command buffer, wherein the central processing unit executes a device driver to create the direct memory access packet.

39. The method of claim 36, comprising, by the central processing unit, creating a first type of direct memory access packet for programmable workloads that have a dependency relationship and creating a second type of direct memory access packet for programmable workloads that do not have a dependency relationship, wherein the first type of direct memory access packet is different than the second type of direct memory access packet.

40. The method of claim 39, wherein the first type of direct memory access packet comprises a synchronization instruction between two of the dispatch instructions, and the second type of direct memory access packet does not comprise any synchronization instructions between the dispatch instructions.

41. The method of claim 36, comprising inserting in the direct memory access packet a synchronization instruction to ensure that execution of one of the programmable workloads by the graphics processing unit finishes before the graphics processing unit begins execution of another of the programmable workloads.

42. One or more machine readable storage media comprising a plurality of instructions stored thereon that in response to being executed result in a computing device:
creating a direct memory access packet, the direct memory access packet comprising a separate dispatch instruction for each of the programmable workloads;
executing the programmable workloads, each of the programmable workloads comprising a set of graphics processing unit instructions; wherein each of the separate dispatch instructions in the direct memory access packet is to initiate processing of one of the programmable workloads by a graphics processing unit of the computing device; and
communicating the direct memory access packet from memory accessible by the central processing unit to memory accessible by the graphics processing unit.

43. The one or more machine readable storage media of claim 42, wherein the instructions result in the computing device creating a command buffer comprising dispatch commands embodied in human-readable computer code, wherein the dispatch instructions in the direct memory access packet correspond to the dispatch commands in the command buffer.

44. The one or more machine readable storage media of claim 43, wherein the instructions result in the computing device executing a user space driver to create the command buffer and executing a device driver to create the direct memory access packet.

45. The one or more machine readable storage media of claim 42, wherein the instructions result in the computing device creating a first type of direct memory access packet for programmable workloads that have a dependency relationship and creating a second type of direct memory access packet for programmable workloads that do not have a dependency relationship, wherein the first type of direct memory access packet is different than the second type of direct memory access packet.

46. The one or more machine readable storage media of claim 45, wherein the first type of direct memory access packet comprises a synchronization instruction between two of the dispatch instructions, and the second type of direct memory access packet does not comprise any synchronization instructions between the dispatch instructions.

47. The one or more machine readable storage media of claim 45, wherein the instructions result in the computing device inserting in the direct memory access packet a synchronization instruction to ensure that execution of one of the programmable workloads by the graphics processing unit finishes before the graphics processing unit begins execution of another of the programmable workloads.

48. A computing device for submitting programmable workloads to a graphics processing unit, each of the programmable workloads comprising a set of graphics processing unit instructions, the computing device comprising:
a graphics subsystem to facilitate communication between a user space application and the graphics processing unit; and
a batch submission mechanism to create a single command buffer comprising separate dispatch commands for each of the programmable workloads, wherein each of the separate commands in the direct memory access packet is to separately initiate processing by the graphics processing unit of one of the programmable workloads.

49. The computing device of claim 48, comprising a device driver to create a direct memory access packet, the direct memory access packet comprising graphics processing unit instructions corresponding to the dispatch commands in the command buffer.

50. The computing device of claim 48, wherein the dispatch commands are to cause the graphics processing unit to execute all of the programmable workloads in parallel.

51. The computing device of claim 48, comprising a synchronization mechanism to insert into the command buffer a synchronization command to cause the graphics processing unit to complete execution of a programmable workload before beginning the execution of another programmable workload.

52. The computing device of claim 51, wherein the synchronization mechanism is embodied as a component of the batch submission mechanism.

53. The computing device of claim 48, wherein the batch submission mechanism is embodied as a component of the graphics subsystem.

54. The computing device of claim 53, wherein the graphics subsystem is embodied as one or more of: an application programming interface, a plurality of application programming interfaces, and a runtime library.
